(19) United States
(12) Patent Application Publication
(10) Pub. No.: US 2024/0254353 A1
(43) Pub. Date: Aug. 1, 2024

(54) Ink Jet Ink Composition, Ink Set, And Recording Method

(71) Applicant: SEIKO EPSON CORPORATION, Tokyo (JP)

(72) Inventors: Takako SUGIYAMA, Azumino (JP); Yuta ASAKAWA, Azumino (JP); Keigo ANDO, Matsumoto (JP)

(21) Appl. No.: 18/427,892

(22) Filed: Jan. 31, 2024

(30) Foreign Application Priority Data
Feb. 1, 2023 (JP) 2023-013820

(51) Int. Cl. C09D 11/36; B41J 2/21; B41M 3/00; B41M 7/00; C09D 11/322; C09D 11/38; C09D 11/40

(52) U.S. Cl. CPC C09D 11/36; B41J 2/2117; B41M 3/008; B41M 7/009; C09D 11/322; C09D 11/38; C09D 11/40

(57) ABSTRACT

An ink jet ink composition is a white ink jet ink composition for use in printing on a recording medium that is a low-absorbent recording medium or a non-absorbent recording medium. The ink jet ink composition is an aqueous ink containing water, a white pigment, an organic solvent, resin particles, an alkanolamine, and an inorganic alkali. The organic solvent contains a diol-based organic solvent. The diol-based organic solvent contains a diol-based organic solvent with a normal boiling point of 220° C. or lower. The content of the diol-based organic solvent with a normal boiling point of 220° C. or lower is 60% by mass or more with respect to the total mass of the diol-based organic solvent. The resin particles contain a resin with a glass transition point of 75° C. or lower.

The present application is based on, and claims priority from JP Application Serial Number 2023-013820, filed Feb. 1, 2023, the disclosure of which is hereby incorporated by reference herein in its entirety.

### BACKGROUND

### 1. Technical Field

The present disclosure relates to an ink jet ink composition, an ink set, and a recording method.

### 2. Related Art

Aqueous white ink jet ink compositions containing a white pigment and resin particles are known in the related art. For example, JP-A-2021-17005 discloses a white ink composition containing, titanium oxide, a urethane resin, and the like.

However, white ink compositions have insufficient ink storage stability. In addition, it may be difficult to ensure drying properties after being applied to a recording medium. Further, when white ink compositions are used for printing on low-absorbent recording media or non-absorbent recording media, there is a possibility that deformation such as curling occurs in a printed product. That is, a white ink jet ink composition that exhibits improvements in the above various properties with a good balance has been demanded.

### SUMMARY

An ink jet ink composition is a white ink jet ink composition for use in printing on a recording medium that is a low-absorbent recording medium or a non-absorbent recording medium. The ink jet ink composition is an aqueous ink containing water, a white pigment, an organic solvent, resin particles, an alkanolamine, and an inorganic alkali. The organic solvent contains a diol-based organic solvent. The diol-based organic solvent contains a diol-based organic solvent with a normal boiling point of 220° C. or lower. The content of the diol-based organic solvent with a normal boiling point of 220° C. or lower is 60% by mass or more with respect to the total mass of the diol-based organic solvent. The resin particles contain a resin with a glass transition point of 75° C. or lower.

An ink set includes the ink jet ink composition and a non-white ink jet ink composition that is an aqueous ink containing water, a non-white pigment, an organic solvent, and resin particles.

A recording method uses the ink jet composition and includes a white ink adhesion step of ejecting the ink jet ink composition from an ink jet head to cause the ink jet ink composition to adhere to the recording medium.

### BRIEF DESCRIPTION OF THE DRAWINGS

FIG. 1 is a table showing the compositions of white inks according to examples.

FIG. 2 is a table showing the compositions of white inks according to comparative examples and non-white inks according to the examples.

FIG. 3 is a table showing the contents, the evaluation results, and the like of ink sets according to the examples.

FIG. 4 is a table showing the contents, the evaluation results, and the like of ink sets according to the comparative examples.

### DESCRIPTION OF EMBODIMENTS

An ink jet ink composition, a non-white ink jet ink composition, an ink set, and a recording method of the present embodiment will be described below. The present disclosure is not limited by the following embodiment.

White ink compositions have a problem in that it is difficult to improve various properties including storage stability and the drying properties and deformation reduction of a printed product with a good balance.

Specifically, white ink compositions tend to have poor storage stability for the reason that it is difficult to achieve dispersion stability of pigments and other reasons. In addition, to ensure shielding properties, the pigment concentration is set to be relatively high. For this reason, it is difficult to improve dispersion stability and clogging recoverability in an ink jet head.

In a composition using a diol-based organic solvent having a relatively high normal boiling point as a main organic solvent, it may be difficult to ensure drying properties after being applied to a recording medium. When the drying properties are improved, the clogging recoverability may be likely to become worse. Further, when white ink compositions are used for printing on low-absorbent recording media or non-absorbent recording media, there is a possibility that deformation such as curling occurs in the printed product. That is, a white ink jet ink composition that exhibits improvements in the above various properties with a good balance has been demanded.

### 1. INK JET INK COMPOSITION

The ink jet ink composition according to the present embodiment is a white ink jet ink composition for use in printing on a recording medium that is a low-absorbent recording medium or a non-absorbent recording medium. The ink set according to the present embodiment, including the ink jet ink composition and a non-white ink jet ink composition, is also used for printing on the recording medium.

In the following description, the ink jet ink composition of the present embodiment will also be referred to simply as “white ink”, and the non-white ink jet ink composition forming the ink set together with the white ink will also be referred to simply as “non-white ink”. In addition, the white ink and the non-white ink may also be referred to simply as “ink” in a collective manner. The white ink and the non-white are each an aqueous ink. “Aqueous ink” as used herein refers to an ink containing at least water as a main solvent.

The white ink contains water, a white pigment, an organic solvent, resin particles, an alkanolamine, and an inorganic alkali. The white ink is used in order to form, for example, a background of the non-white ink on a transparent recording medium. That is, by forming a coating of the white ink as the background, an image or the like formed by the non-white ink is displayed in a conspicuous manner.

### 1.1. Components

### 1.1.1. Water

Water is a component that evaporates during drying after the white ink is caused to adhere to the recording medium. As water, water with ionic impurities removed as much as possible is used, including ion exchanged water, ultrafiltered water, reverse osmotic water, pure water such as distilled water, and ultrapure water, for example. When water sterilized with UV irradiation, addition of hydrogen peroxide, or the like is used, the growth of mold and bacteria is suppressed when the treated liquid is stored for a long term. The white ink may be one further containing a solvent other than water, such as an organic solvent, as a main solvent in addition to water.

The content of water in the white ink is set as appropriate in accordance with the type of the recording medium and the use of the white ink. The content of water in the white ink, which is not particularly limited, is preferably 30% by mass or more with respect to the total mass of the white ink. Further, the content of water in the white ink is preferably 30% by mass or more and 95% by mass or less and more preferably 30% by mass or more and 85% by mass or less. Further, the content of water is preferably 35% by mass or more and 80% by mass or less and more preferably 40% by mass or more and 75% by mass or less. This makes it easy to adjust physical properties such as viscosity of the white ink, drying properties upon adhesion to the recording medium, and the like.

### 1.1.2. White Pigment

The white pigment is a coloring material that remains on the recording medium to show white when the white ink is caused to adhere to the recording medium. Examples of the white pigment include inorganic compound particles. Examples of the inorganic compound particles include inorganic oxides, inorganic sulfides, inorganic carbonates, and inorganic silicates.

Specific examples of the white pigment include C.I. (Colour Index Generic Name) Pigment White 1 (basic lead carbonate), 4 (zinc oxide), 5 (a mixture of zinc sulfide and barium sulfate), 6 (titanium dioxide), 6: 1 (titanium dioxide containing other metal oxides), 7 (zinc sulfide), 18 (calcium carbonate), 19 (clay), 20 (titanium dioxide coated mica), 21 (barium sulfate), 22 (gypsum), 26 (magnesium oxide and silicon dioxide), 27 (silicon dioxide), 28 (calcium silicate anhydride), antimony trioxide, and zirconium dioxide. Among these, C.I. Pigment White 6 (titanium dioxide) is preferably used from the viewpoint of improving the shielding properties of a coating to be formed on the recording medium.

As the white pigment, particles having a hollow structure may be used. The particles having a hollow structure may be either inorganic particles or organic particles. In the following description, the particles having a hollow structure will also be referred to as “hollow particles”.

“Hollow structure” refers to a structure containing at least a substance having a different refractive index. “Hollow particles” specifically refers to particles having a structure in which a space is surrounded by a shell, such as a core-shell structure. The material of the core of the hollow particles may be either liquid or gas. As the hollow particles, known ones can be used.

The content of the white pigment in the white ink, which is not particularly limited, is preferably 5.0% by mass or more and 20.0% by mass or less and more preferably 7.5% by mass or more and 18.0% by mass or less with respect to the total mass of the white ink. Further, the content of the white pigment in the white ink is preferably 9.0% by mass or more and 17.0% by mass or less and more preferably 10.0% by mass or more and 17.0% by mass or less. This can reduce an increase in viscosity or the like in the white ink and a decrease in ejection stability in an ink jet head and can improve the shielding properties of the coating.

The average particle size of the white pigment, which is not particularly limited, is preferably 100 nm or more and 400 nm or less from the viewpoint of the shielding properties of the coating, dispersion stability, and the like. “Average particle size” as used herein refers to a volume-based particle size distribution (50%) measured by the dynamic light scattering method.

### 1.1.3. Organic Solvent

The white ink contains the organic solvent. The content of the organic solvent is preferably 5% by mass or more and 30% by mass or less, more preferably 10% by mass or more and 25% by mass or less, and even more preferably 15% by mass or more and 23% by mass or less with respect to the total mass of the white ink. This can suitably adjust the physical properties such as viscosity and drying properties of the white ink.

### 1.1.3.1. Diol-Based Organic Solvent

The organic solvent contains a diol-based organic solvent. Among diol-based organic solvents, a diol-based organic solvent with a normal boiling point of 220° C. or lower is contained. The diol-based organic solvent with a normal boiling point of 220° C. or lower has the function of improving the drying properties of the white ink caused to adhere to the recording medium.

Examples of the diol-based organic solvent include compounds with two hydrogen atoms of an alkane replaced by hydroxy groups. The alkane preferably has two to eight carbon atoms and more preferably has three to six carbon atoms. Specifically, the diol-based organic solvent is preferably a 1,2-alkanediol.

Further examples of the diol-based organic solvent include condensates in which molecules of a compound with two hydrogen atoms of an alkane replaced by hydroxy groups are condensed through the two hydroxy groups. The number of condensed units in the condensates is preferably two to four. Among these, the compounds with two hydrogen atoms of an alkane replaced by hydroxy groups are preferred.

Examples of the diol-based organic solvent with a normal boiling point of 220° C. or lower include 1,2-octanediol (131° C.), 2,3-butanediol (177° C.), 1,2-propanediol (188° C.), 1,2-butanediol (193° C.), 1,2-ethanediol (197° C.), 1,3-butanediol (207° C.), 1,3-pentanediol (209° C.), 1,2-pentanediol (210° C.), 1,3-propanediol (213° C.), and 3-methyl-1,3-butanediol (204° C.). The value in the parentheses following the name of each compound is the normal boiling point of the compound.

The content of the diol-based organic solvent with a normal boiling point of 220° C. or lower is 60% by mass or more, preferably 70% by mass or more and 90% by mass or less, and more preferably 75% by mass or more and 80% by mass or less with respect to the total mass of the diol-based organic solvent. This further improves the drying properties of the white ink caused to adhere to the recording medium. When the drying properties of the white ink improve, clogging recoverability in a nozzle or the like of an ink jet head is likely to decrease. However, in the present embodiment, the decrease in clogging recoverability is reduced by the action of the alkanolamine and the inorganic alkali described below.

The content of the diol-based organic solvent with a normal boiling point of 220° C. or lower with respect to the total mass of the ink is preferably 5% by mass or more and 30% by mass or less, more preferably 10% by mass or more and 25% by mass or less, and even more preferably 15% by mass or more and 20% by mass or less.

The diol-based organic solvent preferably does not contain a diol-based organic solvent with a normal boiling point of higher than 230° C. in an amount of more than 2% by mass with respect to the total mass of the diol-based organic solvent and more preferably does not contain the diol-based organic solvent with a normal boiling point of higher than 230° C. That is, the diol-based organic solvent with a normal boiling point of higher than 230° C. may be contained, but when it is contained or not contained, it is preferably not contained in an amount of more than 2% by mass. This further improves the drying properties of the white ink caused to adhere to the recording medium.

Examples of the diol-based organic solvent with a normal boiling point of higher than 230° C. include 1,5-pentanediol (239° C.) and 1,6-hexanediol (249° C.). The diol-based organic solvent may contain a diol-based organic solvent with a normal boiling point of higher than 220° C. and 230° C. or lower. Examples of the diol-based organic solvent with a normal boiling point of higher than 220° C. and 230° C. or lower include 1,2-hexanediol (223° C.). The value in the parentheses following the name of each compound is the normal boiling point of the compound.

“Normal boiling point” refers to a boiling point under an external pressure of 1 atm and is determined by, for example, measuring the boiling point under 1 atm using a known boiling point measuring apparatus.

### 1.1.3.2. Other Organic Solvents

The white ink may contain organic solvents other than the diol-based organic solvent, but when they are contained or not contained, they are preferably not contained in an amount of more than 5% by mass with respect to the total mass of the white ink and more preferably not contained. This further improves the drying properties of the white ink caused to adhere to the recording medium.

Examples of the other organic solvents include glycerol; amide-based solvents such as 2-pyrrolidone, N-methyl-2-pyrrolidone, N-ethyl-2-pyrrolidone, and N-vinyl-2-pyrrolidone; glycol ethers such as alkylene glycol monoethers and alkylene glycol diethers; triols or higher polyols; and monoalcohols.

The other organic solvents are selected as appropriate in accordance with the characteristics of the white ink and the printed product, the behavior of the white ink upon adhesion to the recording medium, and the like.

### 1.1.4. Resin Particles

The resin particles are responsible for the physical properties of the coating formed by the white ink on the recording medium. Examples of the physical properties include adhesion to the recording medium, surface hardness, and mechanical characteristics. As the resin particles, resin particles having water dispersibility are used. The resin particles having water dispersibility are preferably of the self-emulsifying type.

The resin particles contain a resin with a glass transition point of 75° C. or lower. When the white ink is used for printing films for soft packaging in particular, the resin particles more preferably contain a resin with a glass transition point of 30° C. or lower. The glass transition point of the resin can be measured by a known method such as differential scanning calorimetry.

In commercial printing and industrial printing, low-absorbent recording media or non-absorbent recording media may be used. Among these, films that have a small thickness and deform easily may be used as recording media for soft packaging. When such recording media are used, the white ink, when dried to form a coating, may cause deformation such as curling and distortion in the recording media due to the resin particles in the white ink. On the other hand, when the glass transition point of the resin is within the above range, the flexibility of the coating improves, thus reducing the deformation of the recording media. In addition, when the printed product is subjected to lamination, laminate strength also improves.

Meanwhile, in the resin particles containing the resin with a glass transition point of 75° C. or lower, the resin particles are likely to gather into aggregates, and the aggregates tend to have poor redispersibility. In particular, when the dispersion stability of the white pigment is poor, and the white pigment gathers into aggregates, the resin particles get caught therein, generating composite aggregates of the white pigment and the resin particles, which tends to result in particularly poor clogging recoverability and redispersibility. The white ink of the present embodiment has excellent dispersion stability of the white pigment and is thus unlikely to generate composite aggregates of the white pigment and the resin particles, which is preferred.

The content of the resin particles in the white ink, which is not particularly limited, is preferably 1.0% by mass or more and 15.0% by mass or less, more preferably 3.0% by mass or more and 12.0% by mass or less, and particularly preferably 4.0% by mass or more and 10.0% by mass or less with respect to the total mass of the white ink. This improves laminate strength, scratch resistance, and blocking resistance.

The average particle size of the resin particles in the white ink is preferably 10 nm or more and 300 nm or less and more preferably 20 nm or more and 200 nm or less. This improves the dispersion stability of the resin particles, the ejection stability of the white ink in an ink jet head, and the like.

Examples of the resin include urethane-based resins, acrylic-based resins, polyester-based resins, and polyolefin-based resins. Among these, the resin is preferably one or more of a urethane-based resin and an acrylic-based resin. When the urethane-based resin is used, the strength of the coating improves; thus, the urethane-based resin is suitable when the printed product is subjected to lamination. The use of the acrylic-based resin further improves the dispersion stability and the clogging recoverability of the white ink. “Acrylic-based resin” as used herein includes a copolymer with a raw material monomer other than an acrylic compound, such as a styrene-acrylic resin. As the urethane-based resin and the acrylic-based resin, known resin emulsions or the like can be used.

The urethane-based resin is not particularly limited so long as it is a resin having a urethane bond in the molecule. Specific examples of the urethane-based resin include polyether type urethane-based resins containing an ether bond in the main chain, polyester type urethane-based resins containing an ester bond in the main chain, and polycarbonate type urethane-based resins containing a carbonate bond in the main chain.

As the urethane-based resin, commercially available emulsions may be used. Examples of commercially available products of urethane-based resin emulsions include Sancure (registered trademark) 2710 (product name) from Lubrizol Japan Limited; Permarin (registered trademark) UA-150 (product name) from Sanyo Chemical Industries, Ltd.; Superflex (registered trademark) 460, 470, 610, 700, and 820 (product names) from DKS Co. Ltd.; NeoRez (registered trademark) R-9660, R-9637, and R-940 (product names) from Kusumoto Chemicals, Ltd.; Adeka Bontighter (registered trademark) HUX-380 and 290K (product names) from Adeka Corporation; Takelac (registered trademark) W-605, W-635, W-6020, W-6061, and WS-6021 (product names) from Mitsui Chemicals, Inc.; and Hydran (registered trademark) WLS-201 (product name) from DIC Corporation. One or more of these urethane-based resin emulsions can be used.

Specific examples of the acrylic-based resin include (meth)acrylic resins, styrene-(meth)acrylic resins, and (meth)acrylic-urethane resins. In the present specification, (meth)acrylic refers to either acrylic or methacrylic corresponding thereto.

As the acrylic-based resin, commercially available emulsions may be used. Examples of commercially available products of acrylic-based resin emulsions include Mowinyl (registered trademark) 966A (product name) from The Nippon Synthetic Chemical Industry Co., Ltd.; NK-Binder R-5HN (product name) from Shin-Nakamura Chemical Co., Ltd.; Joncryl (registered trademark) 7100 (product name) from BASF; and QE-1042, X-436, PE-1126, JE-1113, and KE-1148 (product names) from Seiko PMC Corporation. One or more of these acrylic-based resin emulsions can be used.

### 1.1.5. Alkanolamine

The alkanolamine may be a pH adjusting agent that adjusts the pH of the white ink to maintain the dispersion stability of the white pigment and the resin particles. An inorganic amine described below may also be a pH adjusting agent. In the related art, it has been difficult to improve dispersion stability in some cases even when an alkanolamine or an inorganic amine is used alone. When dispersion stability decreases over time, there is a possibility that storage stability and clogging recoverability become worse. Thus, in the white pigment, sedimentation or the formation of hard cake may occur depending on average particle size or specific gravity.

In contrast, in the white ink, the use of the alkanolamine as an organic alkali and the inorganic alkali in combination improves dispersion stability and clogging recoverability. In particular, the alkanolamine has the effect of improving the redispersibility of almost solidified white ink, contributing to an improvement in clogging recoverability.

The content of the alkanolamine in the white ink is preferably 1.0% by mass or less with respect to the total mass of the white ink. This can further improve the dispersion stability of the white pigment in the white ink and the clogging recoverability of the white ink. A resin with a relatively low glass transition point is likely to aggregate along with the formation of hard cake of the white pigment during the storage of the white ink; however, containing the alkanolamine reduces the aggregation of the resin.

The content of the alkanolamine is preferably 0.05% by mass or more and 0.70% by mass or less and more preferably 0.10% by mass or more and 0.50% by mass or less with respect to the total mass of the white ink.

Examples of the alkanolamine include triethylamine, trimethylamine, monoethanolamine, diethanolamine, diethylethanolamine, triethanolamine, and triisopropanolamine. These alkanolamines may be added to the white ink in the form of a salt.

### 1.1.6. Inorganic Alkali

As with the alkanolamine, the inorganic alkali may function as a pH adjusting agent in the white ink.

The content of the inorganic alkali in the white ink is preferably 0.50% by mass or less with respect to the total mass of the white ink. This can further improve the dispersion stability of the white pigment and the clogging recoverability of the white ink.

Further, the content is preferably 0.30% by mass or less, more preferably 0.01% by mass or more and 0.20% by mass or less, and even more preferably 0.03% by mass or more and 0.20% by mass or less.

Examples of the inorganic alkali include inorganic salts such as sodium hydroxide, potassium hydroxide, and lithium hydroxide; and sodium carbonate, sodium hydrogencarbonate, potassium hydrogencarbonate, monosodium phosphate, monopotassium phosphate, disodium phosphate, and trisodium phosphate, which have buffer action. As the inorganic alkali, one or more of these are used.

### 1.1.7. Resin Dispersant

The white ink may contain a resin dispersant that disperses the white pigment. The resin dispersant preferably has an acidic group. The resin dispersant has action in which a hydrophobic part in its molecular structure adsorbs to the particle surface of the white pigment, whereas the acidic group is oriented to a solvent. This can further improve the dispersion stability of the white pigment in the white ink and the clogging recoverability of the white ink. For the dispersion by the resin dispersant, techniques such as phase inversion emulsification and encapsulation may be used.

Examples of the resin dispersant include acrylic-based resins obtained by copolymerization using at least an acrylic-based monomer such as (meth)acrylic acid or a (meth)acrylic acid derivative, maleic acid-based resins obtained by copolymerization using at least maleic acid or a derivative thereof, and amine-based resins having an amine structure, which are preferred.

Specific examples of the resin dispersant include polyacrylic acid partial alkyl esters, polyalkylene polyamines, polyacrylates, styrene-(meth)acrylic acid copolymers, and vinylnaphthalene-maleic acid copolymers. Examples of the acidic group included in the resin dispersant include a carboxy group, a sulfo group, and phosphorus-containing groups. The acidic group may be in the form of a salt.

The resin dispersant has a hydrophilic structural part and a hydrophobic structural part. When the resin dispersant has the acidic group, the acidic group is the hydrophilic structural part. On the other hand, when the resin dispersant does not have the acidic group, the resin dispersant is required to have a hydrophilic structural part other than the acidic group. When the resin dispersant has the acidic group, the dispersion stability of the pigment is more excellent, and further, the drying properties, laminate strength, and the like of the printed product are more excellent, which is preferred.

It is inferred that when the resin dispersant has the acidic group, and when the white ink contains the inorganic alkali, the metal ions of the inorganic alkali act on the acidic group of the resin dispersant, making the dispersion stability of the white pigment more excellent and making the storage stability, the clogging recoverability, and the like of the white ink more excellent.

The content of the resin dispersant in the white ink is preferably 1% by mass or more and 200% by mass or less and more preferably 5% by mass or more and 150% by mass or less with respect to the total mass of the white pigment. Further, the content of the resin dispersant in the white ink is preferably 7% by mass or more and 50% by mass or less and more preferably 10% by mass or more and 40% by mass or less. This further improves the dispersion stability of the white pigment.

### 1.1.8. Surfactant

The white ink may contain a surfactant. Examples of the surfactant include acetylene glycol-based surfactants, silicone-based surfactants, and fluorinated surfactants. The white ink preferably contains the silicone-based surfactant among these surfactants.

The silicone-based surfactant reduces the surface tension of the white ink to improve wettability against the recording medium. In particular, the pH of the white ink is suitably maintained by the alkanolamine and the inorganic alkali, and thus decomposition of the silicone-based surfactant is not likely to occur. Consequently, the action of the silicone-based surfactant is stably exhibited.

Examples of the silicone-based surfactant include polysiloxane-based compounds such as polyether-modified organosiloxanes. As the silicone-based surfactant, commercially available products of polyether-modified organosiloxanes may be used.

Examples of the commercially available products include BYK (registered trademark)-306, BYK-307, BYK-333, BYK-341, BYK-345, BYK-346, and BYK-348 (product names) from BYK-Chemie Japan K.K.; and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (product names) from Shin-Etsu Chemical Co., Ltd.

As the acetylene glycol-based surfactant, commercially available products may be used. Examples of the commercially available products of the acetylene glycol-based surfactant include Surfynol (registered trademark) 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (product names) from Air Products and Chemicals. Inc.; Olfine (registered trademark) B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (product names) from Nissin Chemical Co., Ltd.; and Acetylenol (registered trademark) E00, E00P, E40, and E100 (product names) from Kawaken Fine Chemicals Co., Ltd.

As the fluorinated surfactant, fluorine-modified polymers are preferably used. As the fluorine-modified polymers, commercially available products may be used. Examples of the commercially available products of the fluorine-modified polymers include BYK-340 (product name) from BYK-Chemie Japan K.K.

The content of the surfactant in the white ink, which is not particularly limited, is preferably 0.1% by mass or more and 2.0% by mass or less and more preferably 0.3% by mass or more and 1.0% by mass or less with respect to the total mass of the white ink.

### 1.1.9. Additives

The white ink may contain additives. Examples of the additives include dissolution aids, viscosity adjusting agents, antioxidants, antiseptics, antimold agents, anticorrosive agents, defoaming agents, wax additives, and chelating agents. For these additive, commercially available products may be used.

### 1.2. Method of Preparation

In the preparation of the white ink, first, the above components are mixed together in any order. Subsequently, filtration or the like is performed as needed to remove impurities, foreign matter, and the like. The method for mixing the components includes successively adding the components to a container equipped with a stirrer such as a mechanical stirrer or a magnetic stirrer and stirring and mixing them together. As the method of filtration, known methods such as centrifugal filtration and filter filtration can be employed.

### 1.3. Physical Properties

The surface tension of the white ink at 25° C. is preferably 10 mN/m or more and 40 mN/m or less and more preferably 20 mN/m or more and 40 mN/m or less. This improves the ejection stability of the white ink from an ink jet head. In addition, a high-definition image or the like can be formed on the recording medium. The surface tension of the white ink can be measured using an automatic surface tensiometer CBVP-Z from Kyowa Interface Science Co., Ltd.

The viscosity of the white ink at 20° C. is preferably 2 mPa·s (millipascal seconds) or more and 15 mPa·s or less and more preferably 2 mPa·s or more and 5 mPa·s or less from the same viewpoint as for the surface tension. The viscosity of the white ink can be measured using a viscoelasticity testing machine MCR-300 from Physica. Specifically, the viscosity of the white ink at 20° C. can be determined by adjusting the temperature of the white ink to 20° C., raising the shear rate from 10 to 1,000, and reading the viscosity at a shear rate of 200.

### 2. NON-WHITE INK JET INK COMPOSITION

The non-white ink contains water, a non-white pigment, an organic solvent, and resin particles.

### 2.1. Components

### 2.1.1. Non-White Pigment

The non-white pigment is a coloring material that remains on the recording medium to show a unique, non-white color when the non-white ink is caused to adhere to the recording medium. For the non-white pigment, known organic pigments and known inorganic pigments are used.

Examples of the organic pigments include azo pigments such azo lake pigments, insoluble azo pigments, condensed azo pigments, and chelate azo pigments; polycyclic pigments such as phthalocyanine pigments, perylene pigments, perinone pigments, anthraquinone pigments, quinacridone pigments, dioxazine pigments, thioindigo pigments, isoindolinone pigments, isoindoline pigments, quinophthalone pigments, and diketopyrrolopyrrole pigments; dye lake pigments such as basic dye type lakes and acidic dye type lakes; nitro pigments, nitroso pigments, aniline black, and daylight fluorescent pigments.

Examples of the inorganic pigments include metal oxide pigments such as chromium oxide, carbon black, and luster pigments such as pearl pigments and metallic pigments.

The non-white pigment includes black pigments, yellow pigments, magenta pigments, cyan pigments, and the like. Examples of the black pigment include C.I. Pigment Black 1, 7, and 11.

Examples of the yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

Examples of the magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245 and C.I. Pigment Violet 19, 23, 32, 33, 36, 38, 43, and 50.

Examples of the cyan pigment include C.I. Pigment Blue 1, 2, 3, 15, 15:1, 15:2, 15:3, 15:34, 15:4, 16, 18, 22, 25, 60, 65, and 66 and C.I. Vat Blue 4 and 60.

Examples of non-white pigments other than the above include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

The content of the non-white pigment in the non-white ink is preferably 0.5% by mass or more and 20.0% by mass or less with respect to the total mass of the non-white ink. Further, the content of the non-white pigment in the non-white ink is preferably 1.0% by mass or more and 6.0% by mass or less and more preferably 2.0% by mass or more and 5.0% by mass or less. This improves the color developability of an image or the like to be formed on the recording medium and reduces the occurrence of clogging or the like in an ink jet head.

### 2.1.2. Organic Solvent

The non-white ink contains the organic solvent. The organic solvent is preferably a diol-based organic solvent and preferably contains a diol-based organic solvent with a normal boiling point of 220° C. or lower. For the diol-based organic solvent with a normal boiling point of 220° C. or lower, those described above can be used. The content of the organic solvent is preferably 10% by mass or more and 25% by mass or less and more preferably 13 to 20% by mass with respect to the total mass of the non-white ink. This can suitably adjust the physical properties such as viscosity and drying properties of the non-white ink.

The content of the diol-based organic solvent with a normal boiling point of 220° C. or lower is preferably 60% by mass or more, more preferably 70% by mass or more and 95% by mass or less, and even more preferably 80% by mass or more and 90% by mass or less with respect to the total mass of the diol-based organic solvent.

The content of the diol-based organic solvent with a normal boiling point of 220° C. or lower with respect to the total mass of the diol-based organic solvent of the non-white ink is preferably higher than the content of the diol-based organic solvent with a normal boiling point of 220° C. or lower with respect to the total mass of the diol-based organic solvent of the white ink. The content of the diol-based organic solvent with a normal boiling point of 220° C. or lower with respect to the total mass of the diol-based organic solvent of the non-white ink is more preferably higher by 2% by mass to 30% by mass, even more preferably higher by 5% by mass to 20% by mass, and still even more preferably higher by 10% by mass to 15% by mass than the content of the diol-based organic solvent with a normal boiling point of 220° C. or lower with respect to the total mass of the diol-based organic solvent of the white ink.

For the organic solvent of the non-white ink, organic solvents similar to those for the white ink can be used apart from the diol-based organic solvent with a normal boiling point of 220° C. or lower.

### 2.1.3. Other Components

As for the components other than the non-white pigment in the non-white ink, components similar to those for the white ink described above can be used. As for the organic solvent, components similar to those for the white ink can be used apart from the above.

The non-white ink is less likely to exhibit decreased dispersion stability, clogging recoverability, and the like than the white ink and can contain at least either the alkanolamine or the inorganic alkali as the pH adjusting agent, which is preferred.

### 2.2. Method of Preparation

For the non-white ink, as with the white ink, the method of preparation described above can be employed.

### 2.3. Physical Properties

The surface tension of the non-white ink at 25° C. is preferably 10 mN/m or more and 40 mN/m or less and more preferably 20 mN/m or more and 40 mN/m or less. This improves the ejection stability of the non-white ink from an ink jet head. In addition, a high-definition image or the like can be formed on the recording medium. The surface tension of the non-white ink can be measured by the method described above in the same manner as for the white ink.

The viscosity of the non-white ink at 20° C. is preferably 2 mPa·s or more and 15 mPa·s or less and more preferably 2 mPa·s or more and 5 mPa·s or less from the same viewpoint as for the surface tension. The viscosity of the non-white ink can be measured by the method described above in the same manner as for the white ink.

### 3. INK SET

The ink set according to the present embodiment includes the white ink and the non-white ink. This can provide an ink set including a white ink that exhibits improvements in various properties including dispersion stability, clogging recoverability, drying properties, and deformation reduction of the printed product. In addition, back printing using the white ink can be performed on a light-transmissive recording medium such as a transparent film. This can improve the image quality and appearance of the non-white ink. The ink set is a set of two or more inks which are used as a set to perform recording.

The ink set may have a plurality of non-white inks showing different colors. This enables a color image or the like to be printed on the recording medium.

### 4. INK JET RECORDING APPARATUS

A recording apparatus including an ink jet head used for the recording method of the present embodiment will be described below. As the recording apparatus, known apparatuses such as ink jet printers can be used. Specific examples the known apparatuses include on-carriage type or off-carriage type serial printers and line head printers.

The ink jet head ejects ink droplets and causes them to adhere to the recording medium. The ink jet head has an actuator as a drive unit. Examples of the actuator include piezoelectric elements utilizing the deformation of piezoelectric bodies, electromechanical conversion elements utilizing the displacement of diaphragms through electrostatic attraction, and electrothermal conversion elements utilizing air bubbles caused by heating. In the present embodiment, a recording apparatus having an ink jet head including piezoelectric elements is used.

The ink jet head has a plurality of nozzles that eject ink droplets. In each of the nozzles, an air-liquid interface is present between the ink and the atmosphere of the ink jet head. In a situation in which the ink jet head is not used for a long period of time, the ink solidifies at or near the air-liquid interface, which may cause clogging of the nozzles. In this case, cleaning of the ink jet head is performed to remove the solidified ink. The ease of removing this solidified ink is the clogging recoverability of the ink jet head.

In general, the higher the concentration of solids such as coloring materials and resins in the ink, the more likely clogging recoverability becomes worse. The white ink and the non-white ink of the present embodiment exhibits improved clogging recoverability because of the compositions described above. Thus, time and effort and the number of times of maintenance or the like of the ink jet head can be reduced.

### 5. RECORDING METHOD

The recording method according to the present embodiment uses the white ink and the non-white ink. The recording method includes a white ink adhesion step and a non-white ink adhesion step. In the present embodiment, a recording method in which the non-white ink adhesion step and the white ink adhesion step are performed in this order will be described, but the recording method of the present disclosure is not limited to this order.

### 5.1. Non-White Ink Adhesion Step

In the non-white ink adhesion step, the non-white ink is ejected from the ink jet head of the ink jet recording apparatus to cause it to adhere to the recording medium that is the low-absorbent recording medium or the non-absorbent recording medium. In this case, a transparent recording medium or a light-transmissive recording medium is used, and an image or the like formed by the non-white ink is visually recognized through the recording medium. This method is so-called back printing.

The non-white ink exhibits improved drying properties because of the composition described above, and thus the time required for drying is shortened to enable quick shift to the next step. Before the non-white ink adhesion step, the white ink adhesion step described below may be performed. In this case, one side of the coating of the non-white ink is exposed on the surface of the printed product, but the composition described above ensures the scratch resistance and laminate strength of the coating of the non-white ink.

For the recording medium, the low-absorbent recording medium or the non-absorbent recording medium is used. In particular, the white ink and the non-white ink have excellent drying properties and thus are suitable for the non-absorbent recording medium among the recording media.

Examples of the non-absorbent recording medium include films and plates made of plastic and plates made of glass or metal. The non-absorbent recording medium is preferably a film made of plastic. Using the film made of plastic, sign printing, label printing, soft packaging printing, or the like may be performed.

The film made of plastic may be, for example, a film for soft packaging for soft packaging printing or the like.

The white ink is particularly suitable when the non-absorbent recording medium is the film made of plastic since deformation of the recording medium along with the solidification of the coating is reduced. Further, the white ink is particularly suitable for the film for soft packaging.

Examples of the material of the film made of plastic include plastics such as polyolefins such as polyethylene and polypropylene, polyethylene terephthalate, and nylon.

In the present specification, “low-absorbent recording medium” refers to a recording medium having a property of absorbing little ink, whereas “non-absorbent recording medium” refers to a recording medium having a property of absorbing no ink. Specifically, “low-absorbent recording medium” refers to a recording medium having a water absorption amount in the Bristow method at 30 msec^{1/2} from the start of contact of greater than 0 mL/m² and 10 mL/m² or less. “Non-absorbent recording medium” refers to a recording medium having a water absorption amount in the Bristow method at 30 msec^{1/2} from the start of contact of 0 mL/m².

Examples of the low-absorbent recording medium include recording media including a coating layer with low ink absorptivity at their recording surface.

Examples of the low-absorbent recording medium or the non-absorbent recording medium include recording media that do not include an ink reception layer having ink absorptivity at their printing surface.

The ink set of the present disclosure may be used for non-absorbent recording media other than those for soft packaging. Examples of such recording media include films for signage. Examples of such films include PVC sheets and PET films. When the printed product is provided for uses such as signage, it may be subjected to lamination with a laminate film. Examples of the films also include plastic films for label printing.

### 5.2. White Ink Adhesion Step

It does not matter in what order the white ink adhesion step and the non-white ink adhesion step are performed, but one of these is preferably performed first, and the other is preferably performed later. In this way, the coating of the white ink and the coating of the non-white ink can be caused to adhere to the recording medium in an overlaid manner to form a multilayer coating such that one coating is disposed over the other coating.

In particular, the white ink adhesion step is preferably performed after the non-white ink adhesion step. In the white ink adhesion step, the white ink is ejected from the ink jet head to be caused to adhere to the recording medium. Specifically, the white ink is caused to adhere to the coating of the non-white ink adhering to the recording medium in an overlaid manner. In this process, the white ink may be overlaid only on the coating formed by the non-white ink or may be caused to adhere also to the area other than the coating of the non-white ink. The ink jet head from which the non-white ink is ejected and the ink jet head from which the white ink is ejected may be the same or different from each other.

In back printing, the coating of the non-white ink is covered with the recording medium and the coating of the white ink, whereas one side of the coating of the white ink is exposed. Thus, for the white ink, characteristics such as drying properties, scratch resistance, and laminate strength in lamination are important. The white ink exhibits improvements in these characteristics because of the composition described above.

In particular, the white ink exhibits improved drying properties, and thus the scratch resistance of the coating of the white ink that is perfectly dried is exhibited in a relatively early stage. Thus, for the white ink, the occurrence of scratches due to handling after printing is reduced. That is, the white ink exhibits improved scratch resistance together with improved drying properties. In addition, the time required for drying the white ink is shortened.

When the film for soft packaging is used as the recording medium, the resin particles contained in the white ink reduce deformation of the film for soft packaging. The occurrence of scratches and deformation is reduced, and thus the quality of the printed product can be improved.

### 5.3. Drying Step

The recording method may further include a drying step after the non-white ink adhesion step and the white ink adhesion step. In the drying step, the recording medium to which the non-white ink and the white ink adhere is preferably heated to a temperature of 60° C. or higher and 90° C. or lower. This can promote the drying of the ink adhering to the recording medium.

A heating unit in the drying step is not particularly limited, and a known heating apparatus can be used. Examples of the heating apparatus include hot air apparatuses including an infrared heater and a blowing mechanism. These heating apparatuses may be included in the ink jet recording apparatus or may be separate from the ink jet recording apparatus.

The ink jet recording apparatus may separately include a platen heater or the like that heats a platen through the surface. After or while heating the recording medium by the platen heater, the ink may be caused to adhere thereto. The heating is heating in the ink adhesion steps. The surface temperature of the recording medium in the ink adhesion steps is preferably 20° C. to 50° C., more preferably 30° C. to 45° C., and even more preferably 35° C. to 38° C.

The printed product is produced through the foregoing steps.

### 5.4. Secondary Processing

When the printed product is used for soft packaging, after the drying step, the printed product may be wound in a roll form or may be subjected to secondary processing for packaging. When the printed product is used for signage or the like, the printed product may be subjected to lamination as secondary processing to improve scratch resistance.

In the lamination, the printed product and a laminate film may be bonded together with an adhesive. This bonds the printed product and the laminate film together relatively firmly. Thus, peeling between the printed product and the laminate film is less likely to occur, and the printed product can be used even under harsh conditions.

In the printed product of the present embodiment, the surface of the coating of the white ink and a laminate material are in contact with each other. The white ink exhibits improved laminate strength of the coating and is thus suitable for lamination. The printed product may be subjected to trimming, bookbinding, eyeleting, or the like as appropriate in accordance with its use.

The present embodiment produces the following effects. The present embodiment can improve, with a good balance, various properties including the dispersion stability of the white pigment, the clogging recoverability of the white ink in the ink jet head, and the drying properties and deformation reduction of the printed product. That is, the present embodiment can provide a white ink, an ink set, and a recording method that exhibit improvements in the above various properties.

### 6. EXAMPLES AND COMPARATIVE EXAMPLES

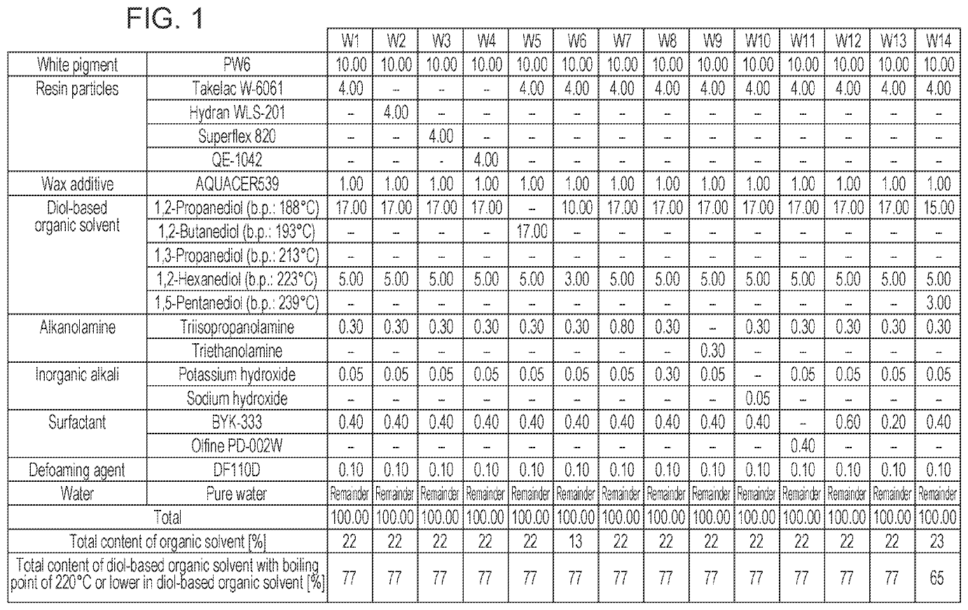

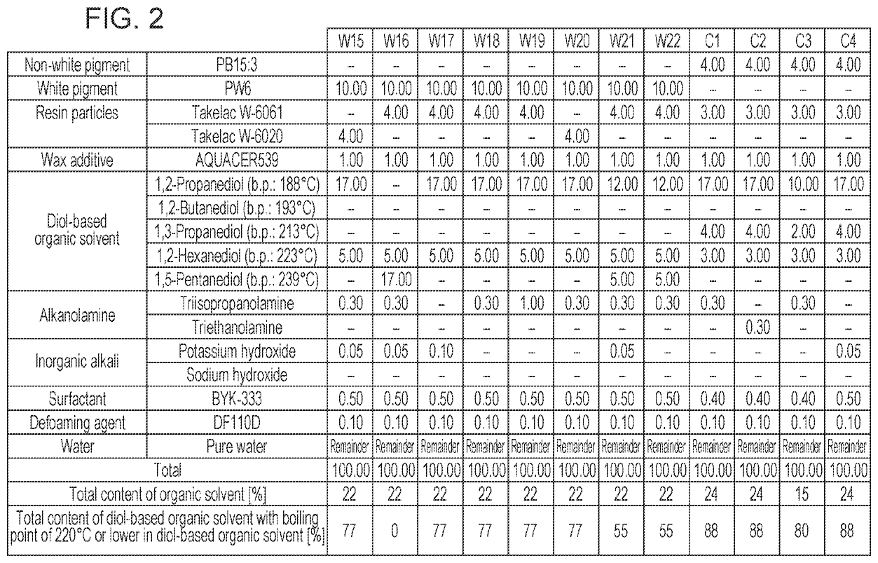

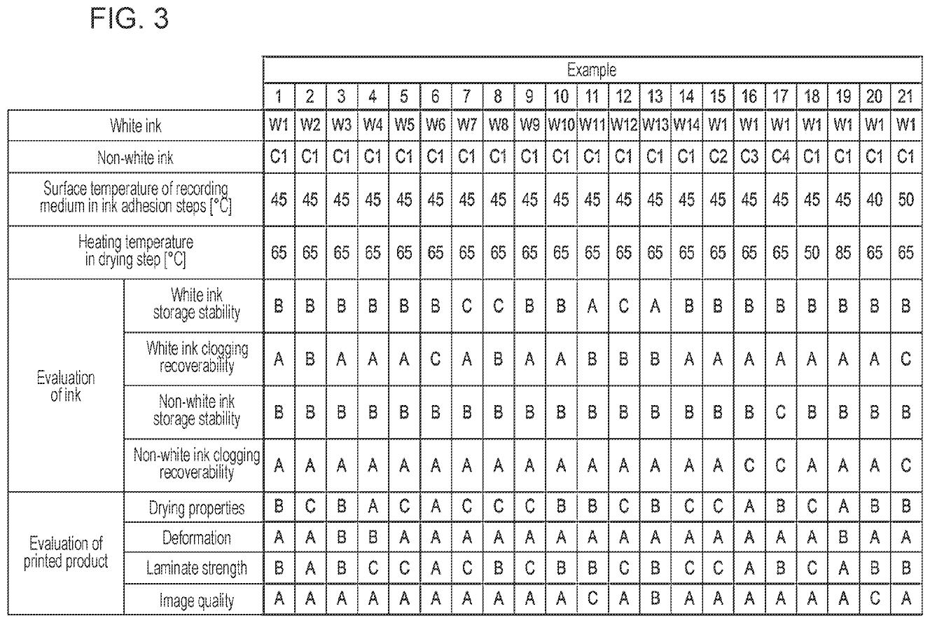

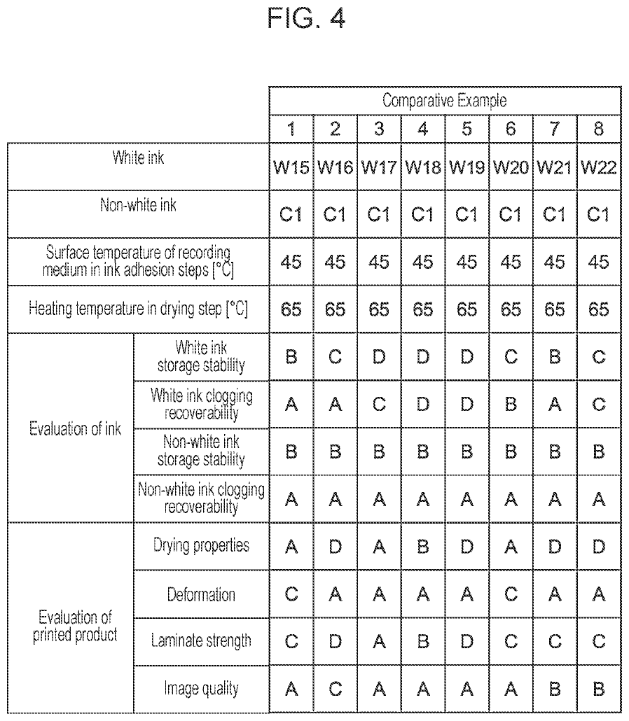

The effects of the present disclosure will be more specifically described with reference to FIG. 1 to FIG. 4 by showing examples and comparative examples. White Inks W1 to W14 shown in FIG. 1 are examples of the white ink of the above embodiment. White Inks W15 to W22 shown in FIG. 2 are white inks of comparative examples. Non-White Inks C1 to C4 shown in FIG. 2 are examples of the non-white ink of the above embodiment. Example 1 to Example 21 shown in FIG. 3 are examples of the ink set of the above embodiment. Comparative Example 1 to Comparative Example 8 shown in FIG. 4 are ink sets of comparative examples. The present disclosure is not limited by the following examples at all.

In the composition sections of FIG. 1 and FIG. 2, the unit of the values is % by mass, and “-” with no value recited means not being contained. In FIG. 1 and FIG. 2, the amounts of the white pigment, the non-white pigment, the resin particles, the wax additive, and the defoaming agent blended are expressed as solid contents. The details of the raw materials shown in FIG. 1 and FIG. 2 are as follows. The white pigment and the non-white pigment were blended as pigment dispersions produced by the method described below.

### White Pigment

PW6: C.I. Pigment White 6 (titanium dioxide)

### Non-White Pigment

PB15: 3: C.I. Pigment Blue 15:3

### Resin Particles

Takelac (registered trademark) W-6061: product name, urethane-based resin emulsion, glass transition point of resin: 25° C., Mitsui Chemicals, Inc.
Hydran (registered trademark) WLS-201: product name, urethane-based resin emulsion, DIC Corporation
Superflex (registered trademark) 820: product name, urethane-based resin emulsion, DKS Co. Ltd.
QE-1042: product name, acrylic-based resin emulsion, Seiko PMC Corporation
Takelac W-6020: product name, urethane-based resin emulsion, glass transition point of resin: 90° C., Mitsui Chemicals, Inc.

### Wax Additive

AQUACER 539: product name, water-soluble wax emulsion, BYK-Chemie Japan K.K.

### Surfactant

BYK (registered trademark) 333: product name, silicone-based surfactant, BYK-Chemie Japan K.K.
Olfine (registered trademark) PD-002W: product name, acetylene glycol-based surfactant, Nissin Chemical Co., Ltd.

### Defoaming Agent

DF110D: Surfynol (registered trademark) DF110D (product name), Nissin Chemical Co., Ltd.

### 6.1. Preparation of Ink

A resin dispersant for use in a white pigment dispersion for the white ink was produced. Specifically, dipropylene glycol in the same amount as the total mass of monomers described below was added to a three-neck flask equipped with a stirrer and a cooling pipe and was heated to 85° C. in a nitrogen atmosphere. Solution A was produced by mixing together 9.1 molar equivalents of stearyl methacrylate, 34.0 molar equivalents of benzyl methacrylate, 31.9 molar equivalents of hydroxyethyl methacrylate, 25.0 molar equivalents of methacrylic acid, and 0.8 molar equivalents of 2-mercaptopropionic acid. Further, Solution B was produced by dissolving 1% by mass of t-butylperoxy-2-ethylhexanoate (Perbutyl O from NOF Corporation) with respect to the total mass of the monomers in 20% by mass of dipropylene glycol with respect to the total mass of the monomers.

Solution A and Solution B were added dropwise to the three-neck flask over 4 hours and 5 hours, respectively. After completion of dropwise addition, they were further reacted for 2 hours, then heated to 95° C., and stirred while being heated for 3 hours to react all unreacted monomers. The disappearance of the monomers was determined by the nuclear magnetic resonance (¹H-NMR) method. The obtained reaction solution was heated to 70° C., 20.0 molar equivalents of dimethylaminoethanol (dimethylethanolamine) as an amine compound was added thereto, then propylene glycol was added thereto, and the mixture was stirred to obtain a 30% by mass dispersion of Dispersing Resin P as a resin dispersant. The weight average molecular weight of Dispersing Resin P was determined by gel permeation chromatography to be 22,000.

Next, using Ready Mill Model LSG-4U-08 from Aimex Co., Ltd., a white pigment dispersion for the white ink was produced. Specifically, added to a container made of zirconia were 45 parts by mass of PF-690 (product name, titanium dioxide, average primary particle size: 210 nm) from Ishihara Sangyo Kaisha, Ltd. as the white pigment, 15 parts by mass of the 30% by mass dispersion of Dispersing Resin P, and 40 parts by mass of ultrapure water. Further, 40 parts by mass of Torayceram (registered trademark) zirconia beads (diameter: 0.5 mm) from Toray Industries, Inc. were added thereto and were slightly mixed with a spatula. The mixture was put into the above apparatus and was dispersed for 5 hours at a rotational speed of 1,000 rpm. After the above operation, filtration with filter cloth was performed to remove the beads and to produce a white pigment dispersion with a solid concentration of titanium dioxide of 45% by mass.

A cyan pigment dispersion for the non-white ink was produced in the same manner as in the method for producing the white pigment dispersion described above except that C.I. Pigment Blue 15:3 from Toyocolor Co., Ltd. was used instead of the white pigment.

Next, in accordance with the compositions in FIG. 1 and FIG. 2, the components were blended together and stirred for each level to uniformly mix the components together and were then filtered with a membrane filter with a pore size of 1 μm to prepare inks of the examples and the comparative examples.

### 6.2. Production of Printed Product

As an ink jet recording apparatus, a modified machine of SC-S80650 from Seiko Epson Corporation as a printer was used. The modified machine included a heating apparatus. The ink jet head of the printer had a nozzle density of each nozzle row of 360 dpi and had 360 nozzles.

By the settings of a preheater and a platen heater of the printer, the surface temperature of the recording medium at the time of ink adhesion was adjusted to the values in FIG. 3 and FIG. 4. A heating apparatus for performing the drying step was installed downstream of the transport direction of the recording medium to which the ink had adhered. The heating apparatus included a heat source and a blowing fan. The temperatures of the heating apparatus and the after heater of the printer were set such that the temperature of the printing surface of the recording medium reached the heating temperature in the drying step in FIG. 3 and FIG. 4.

As the non-absorbent recording medium, a plastic film FOS-AQ50 (product name, thickness: 50 μm) from Futamura Chemical Co., Ltd. was used.

With the ink sets in FIG. 3 and FIG. 4, a cartridge filled with each ink was mounted on the printer. Specifically, in a direction in which the recording medium was transported during printing, the cartridge of the non-white ink was mounted in correspondence with an upstream ink jet head, and the cartridge of the white ink was mounted in correspondence with a downstream ink jet head.

The printer was operated, and during recording, main scanning, which ejected the ink to cause it to adhere to the recording medium, and sub-scanning, which transported the recording medium, were alternately performed. As the recording progressed, first, the non-white ink was printed on the recording medium in a solid pattern, and then the white ink was printed in an overlaid manner on the non-white ink in a solid pattern. In this process, the recording resolution of the non-white ink and the white ink was set to 720 dpi (dots per inch)×720 dpi. The adhesion amount of the non-white ink was set to 6 mg/inch¹, and the adhesion amount of the white ink was set to 12 mg/inch¹. Subsequently, the drying step was performed at each heating temperature to produce a printed product.

### 6.3. Evaluation of Ink

### 6.3.1. Dispersion Stability

As an indicator of the dispersion stability of the ink, storage stability was evaluated. Specifically, the viscosity of each ink at 20° C. immediately after the preparation of the ink was measured by the method for measuring viscosity described above. Next, each ink was put into a 100 ml glass bottle, which was hermetically sealed and was left to stand at 70° C. for 6 days. Subsequently, the viscosity of each ink at 20° C. after being left to stand was measured in the same manner as in the above. The percent change in viscosity at 20° C. after being left to stand with respect to the initial viscosity at 20° C. was evaluated as storage stability in accordance with the following criteria.

### Criteria

A: The percent change is less than 2%.
B: The percent change is 2% or more and less than 5%.
C: The percent change is 5% or more and less than 7%.
D: The percent change is 7% or more.

### 6.3.2. Clogging Recoverability

The clogging recoverability of the nozzles of the ink jet head was evaluated. Specifically, after the printed product was produced, with the ejection of each ink from the ink jet head stopped, the operating state was maintained for 2 hours. That is, pseudo-printing, in which transportation of the recording medium and heating of each heater and heating apparatus were performed, was continued. Subsequently, suction cleaning of the ink jet head was performed. The ink discharge amount of each ink in the suction cleaning was set to 1 ml. After suction cleaning, test printing for checking the ejection state of each nozzle was performed to check the ejection state of all nozzles corresponding to each ink. When not all the nozzles performed normal ejection, the above operation was repeatedly performed. For the number of times of the suction cleaning required for normal ejection of all the nozzles for each ink, the clogging recoverability was evaluated in accordance with the following criteria.

### Criteria

A: All the nozzles performed normal ejection after suction cleaning was performed once.
B: All the nozzles performed normal ejection after suction cleaning was performed two or three times.
C: All the nozzles performed normal ejection after suction cleaning was performed four to six times.
D: Not all the nozzles performed normal ejection after suction cleaning was performed six times.

### 6.4. Evaluation of Printed Product

### 6.4.1. Deformation of Printed Product

The deformation of the printed products was evaluated. Specifically, after the production of the printed products, each printed product was left to stand in a 25° C. temperature environment for 24 hours. Subsequently, the appearance of each printed product was visually observed. The deformation was evaluated in accordance with the following criteria.

### Criteria

A: Deformation such as expansion or contraction or curling was not observed.
B: Deformation such as expansion or contraction or curling was slightly observed.
C: Deformation such as expansion or contraction or curling was clearly observed.

### 6.4.2. Drying Properties of Ink

As an indicator of the drying properties of the ink, the following test was performed. Specifically, for each printed product immediately after production, Bemcot (registered trademark) from Asahi Kasei Corporation was brought into contact with the surface of the printed area and was slid over it 10 times. Subsequently, the slid area of the printed product was visually observed, and the area was touched with a finger to check tack. The drying properties was evaluated in accordance with the following criteria. This evaluation is also a test for the scratch resistance of the printed product.

### Criteria

A: There was neither peeling nor stickiness in the ink coating.
B: There was no peeling but slight stickiness in the ink coating.
C: There was peeling in the ink coating, with the peeled area being less than 10% of the entire area.
D: There was peeling in the ink coating, with the peeled area being 10% or more of the entire area.

### 6.4.3. Image Quality of Printed Product

As an indicator of the image quality of the printed product, density variations were evaluated. Specifically, density variations were visually observed from the back side of the printing surface of each printed product through the recording medium. The image quality was evaluated in accordance with the following criteria.

### Criteria

A: No density variations were observed.
B: Small density variations were slightly observed.
C: Small density variations were conspicuously observed.
D: Large density variations were observed.

### 6.4.4. Laminate Strength

After each printed product was subjected to lamination, as an indicator of laminate strength, peel strength was evaluated. Specifically, the printing surface of each printed product was subjected to lamination using Takelac (registered trademark) A969V and Takenate (registered trademark) A5 as a two-component curing type polyurethane-based adhesive from Mitsui Chemicals, Inc. and CPP Sealant FHK-2 50 (thickness: 50 μm) from Toyobo Co., Ltd. as a sealant film.

Next, after lamination, the printed product was left to stand in a 40° C. atmosphere for 24 hours. Next, the printed product subjected to lamination was cut into a test piece with a size of 200 mm× 15 mm. For the test piece of each level, peel strength measurement was performed in conformity with JIS Z0237 using a universal material testing machine TENSILON (registered trademark) RTG-1250 from A&D Company, Limited.

Specifically, the test piece was folded back to 180°, and a length of 25 mm from one end of the test piece in the longitudinal direction was peeled off. Next, the printed product side and laminate material side of the peeled part were separately fixed to upper and lower chucks of the testing machine. Then, the testing machine was operated to measure the peel strength for 50 mm from the end. In this process, the area peeled off in advance was ignored, and only the peel strength of the area that had not been peeled off was evaluated as an effective value. The measurement was performed three times for each level, and an average of the peel strength was calculated. The average of the peel strength of each level was evaluated as the laminate strength in accordance with the following criteria.

### Criteria

A: The average of the peel strength was 1.5 N/15 mm or more.
B: The average of the peel strength was 1.0 N/15 mm or more and less than 1.5 N/15 mm.
C: The average of the peel strength was 0.5 N/15 mm or more and less than 1.0 N/15 mm.
D: The average of the peel strength was less than 0.5 N/15 mm.

### 6.5. Summary of Evaluation Results

As shown in FIG. 3, in the evaluation of the white inks and the non-white inks of the examples, all the examples were evaluated as C or higher. In the evaluation of the printed products of the examples also, all the examples were evaluated as C or higher. This shows that, in the examples, various properties including the dispersion stability of the white pigment and the non-white pigment, the clogging recoverability of the ink jet head, the drying properties and deformation reduction of the printed product, and image quality are improved with a good balance.

On the other hand, as shown in FIG. 4, in the evaluation of the white inks of the comparative examples, Comparative Examples 3, 4, and 5 were evaluated as D. In the evaluation of the printed products of the comparative examples, Comparative Examples 2, 5, 7, and 8 were evaluated as D. This shows that it is difficult for the comparative examples to achieve improvements in the above various properties with a good balance.

Although not shown in the table, separately from the above, in Comparative Example 3 and Comparative Example 4, two white inks were prepared in the same manner as White Inks W17 and W18 except that Polyvinylpyrrolidone K-30 from Nippon Shokubai Co., Ltd. was used as the resin dispersant for W17 and W18. Evaluation was performed in the same manner as in Comparative Example 3 and Comparative Example 4 using these inks. They were both evaluated as C for the storage stability and were both evaluated as D for the drying properties of the ink. This result shows that the white ink has excellent storage stability and excellent drying properties when the resin dispersant has an acidic group and when the white ink contains an alkanolamine and an inorganic alkali.

What is claimed is:

1. A white ink jet ink composition for use in printing on a recording medium that is a low-absorbent recording medium or a non-absorbent recording medium, the ink jet ink composition being an aqueous ink comprising:
water;
a white pigment;
an organic solvent;
resin particles;
an alkanolamine; and
an inorganic alkali, wherein the organic solvent contains a diol-based organic solvent,
the diol-based organic solvent contains a diol-based organic solvent with a normal boiling point of 220° C. or lower,
a content of the diol-based organic solvent with a normal boiling point of 220° C. or lower is 60% by mass or more with respect to a total mass of the diol-based organic solvent, and
the resin particles contain a resin with a glass transition point of 75° C. or lower.

2. The ink jet ink composition according to claim 1, wherein
with respect to a total mass of the ink jet ink composition,
a content of the alkanolamine is 1.0% by mass or less, and
a content of the inorganic alkali is 0.3% by mass or less.

3. The ink jet ink composition according to claim 1, wherein a content of the organic solvent is 10% by mass or more and 25% by mass or less with respect to a total mass of the ink jet ink composition.

4. The ink jet ink composition according to claim 1, wherein the resin is one or more of a urethane-based resin and an acrylic-based resin.

5. The ink jet ink composition according to claim 1, wherein the diol-based organic solvent does not contain a diol-based organic solvent with a normal boiling point of higher than 230° C. in an amount of more than 2% by mass with respect to the total mass of the diol-based organic solvent.

6. The ink jet ink composition according to claim 1, wherein the organic solvent does not contain an organic solvent other than the diol-based organic solvent in an amount of more than 5% by mass with respect to a total mass of the ink jet ink composition.

7. The ink jet ink composition according to claim 1, further comprising a resin dispersant dispersing the white pigment, wherein the resin dispersant has an acidic group.

8. The ink jet ink composition according to claim 1, wherein the recording medium is the non-absorbent recording medium.

9. The ink jet ink composition according to claim 1, further comprising a silicone-based surfactant.

10. An ink set comprising:
the ink jet ink composition according to claim 1; and
a non-white ink jet ink composition that is an aqueous ink containing
water,
a non-white pigment,
an organic solvent, and
resin particles.

11. The ink set according to claim 10, wherein
the non-white ink jet ink composition contains the diol-based organic solvent with a normal boiling point of 220° C. or lower as the organic solvent, and
a content of the organic solvent is 10% by mass or more and 25% by mass or less with respect to a total mass of the non-white ink jet ink composition.

12. A recording method using the ink jet composition according to claim 1, the method comprising a white ink adhesion step of ejecting the ink jet ink composition from an ink jet head to cause the ink jet ink composition to adhere to the recording medium.

13. The recording method according to claim 12, further comprising a non-white ink adhesion step of ejecting a non-white ink jet ink composition that is an aqueous ink containing water, a non-white pigment, an organic solvent, and resin particles from an ink jet head to cause the non-white ink jet ink composition to adhere to the recording medium.

14. The recording method according to claim 13, wherein
the white ink adhesion step is performed after the non-white ink adhesion step, and
the ink jet ink composition is caused to adhere to the non-white ink jet ink composition adhering to the recording medium in an overlaid manner.

15. The recording method according to claim 13, further comprising a drying step of heating the recording medium to a temperature of 60° C. or higher and 90° C. or lower after the non-white ink adhesion step and the white ink adhesion step.
